(19) United States
(12) Patent Application Publication
(10) Pub. No.: US 2026/0003550 A1
(43) Pub. Date: Jan. 1, 2026

(54) PRINTING SYSTEM, METHOD FOR CONTROLLING PRINTING SYSTEM, AND PRINTING DEVICE

(71) Applicant: SEIKO EPSON CORPORATION, TOKYO (JP)

(72) Inventor: Nobutada MIZUSAWA, SAPPORO-SHI (JP)

(21) Appl. No.: 19/251,897

(22) Filed: Jun. 27, 2025

(30) Foreign Application Priority Data
Jun. 28, 2024 (JP) 2024-104901

(51) Int. Cl. G06F 3/12; B41J 3/46

(52) U.S. Cl. CPC G06F 3/1208; B41J 3/46; G06F 3/1243; G06F 3/1256; G06F 3/1287

(57) ABSTRACT

A printing system includes a second terminal device and a printing device capable of communicating with the second terminal device. The printing device has registered first image information, the second terminal device acquires the first image information from the printing device and transmits third image information and second arrangement information relating to relative positions of the first image information and the third image information to the printing device, and the printing device combines, based on reception from the second terminal device, according to the second arrangement information, the first image information and the received third image information and prints the combined image information.

The present application is i based on, and claims priority from JP Application Serial Number 2024-104901, filed Jun. 28, 2024, the disclosure of which is hereby incorporated by reference herein in its entirety.

### BACKGROUND

### 1. Technical Field

The present disclosure relates to a printing system, a method for controlling a printing system, and a printing device.

### 2. Related Art

In the related art, as explained in JP-A-2017-105103, there has been known a label printer serving as a printing device that arranges second image information based on a command received from a host computer serving as a terminal device and an additional image serving as the second image information and combines the second image information with a background image serving as first image information stored in a storage unit and prints a combined image.

JP-A-2017-105103 is an example of the related art.

However, when another terminal device not having the first image information n attempts to use the first image information stored in the printing device and combine the first image information with third image information different from the second image information and print a combined image, convenience is low in the configuration in which the printing device is used explained above, for example, it is difficult to check relative positions of the first image information and the third image information and it is necessary to arrange the third image information using a command.

### SUMMARY

According to an aspect of the present disclosure, there is provided a printing system including: a second terminal device; and a printing device capable of communicating with the second terminal device, wherein the printing device has registered first image information, the second terminal device acquires the first image information from the printing device and transmits third image information and second arrangement information relating to relative positions of the first image information and the third image information to the printing device, and the printing device combines, based on reception from the second terminal device, according to the second arrangement information, the first image information and the received third image information and prints the combined image information.

According to an aspect of the present disclosure, there is provided a control method for a printing system including a second terminal device and a printing device capable of communicating with the second terminal device, the control method including: the printing device registering first image information; the second terminal device acquiring the first image information from the printing device and transmitting third image information and second arrangement information relating to relative positions of the first image information and the third image information to the printing device; and the printing device combining, based on reception from the second terminal device, according to the second arrangement information, the registered first image information and the received third image information and printing the combined image information.

According to an aspect of the present disclosure, there is provided a printing device capable of communicating with a second terminal device and including a printing unit, a control unit, and a storage unit, wherein the storage unit has registered first image information, and, when receiving third image information and second arrangement information relating to relative positions of the first image information and the third image information from the second terminal device, the control unit combines, according to the second arrangement information, the first image information read from the storage unit and the received third image information and prints the combined image information with the printing unit.

### BRIEF DESCRIPTION OF THE DRAWINGS

FIG. 1 is a block diagram illustrating a configuration of a printing system.

FIG. 2 is a flowchart illustrating control of a first terminal device at the time of transmission to a printing device.

FIG. 3 is a schematic diagram illustrating first image information.

FIG. 4 is a schematic diagram illustrating second image information.

FIG. 5 is a schematic diagram illustrating a first preview screen in which the first image information and the second image information before adjustment are combined in the first terminal device.

FIG. 6 is a schematic diagram illustrating a first adjustment screen for inputting first adjustment information in the first terminal device.

FIG. 7 is a schematic diagram illustrating a second preview screen in which the first image information and the second image information after adjustment according to the first adjustment information are combined in the first terminal device.

FIG. 8 is a flowchart illustrating control of the printing device at the time of reception from the first terminal device.

FIG. 9 is a flowchart illustrating control of a second terminal device at the time of transmission to the printing device.

FIG. 10 is a schematic diagram illustrating third image information.

FIG. 11 is a schematic diagram illustrating a third preview screen in which the first image information and the third image information before adjustment are combined in the second terminal device.

FIG. 12 is a schematic diagram illustrating a second adjustment screen for inputting second adjustment information in the second terminal device.

FIG. 13 is a schematic diagram illustrating a fourth preview screen in which the first image information and the third image information after adjustment are combined according to the second adjustment information in the second terminal device.

FIG. 14 is a flowchart illustrating control of the printing device at the time of reception from the second terminal device.

### DESCRIPTION OF EMBODIMENTS

### (1) Configuration of a Printing System

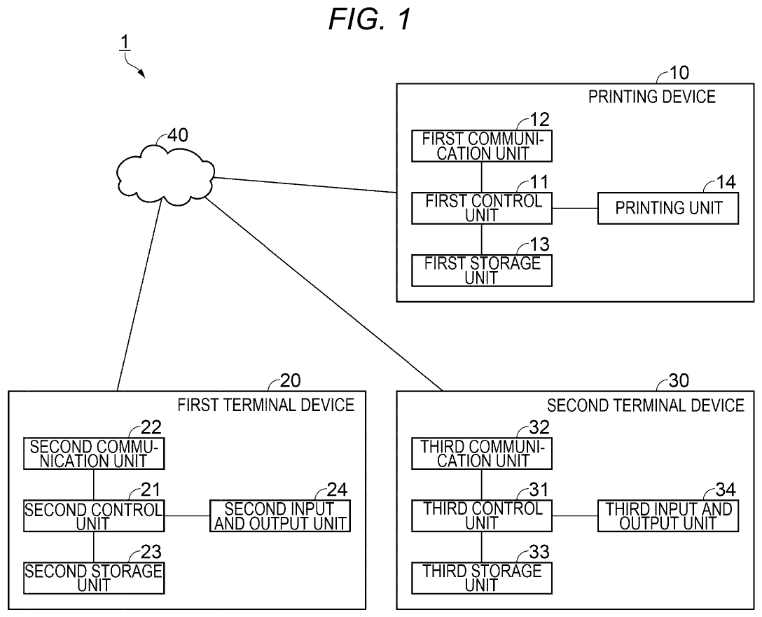

As illustrated in FIG. 1, a printing system 1 includes a printing device 10, a first terminal device 20, and a second terminal device 30. The second terminal device 30 is another device different from the first terminal device 20.

The printing device 10, the first terminal device 20, and the second terminal device 30 are capable of communicating with one another via, for example, a wide area network (WAN) 40, which is the Internet. Note that the WAN 40 may be a network such as a local area network (LAN).

For example, unique Internet Protocol Addresses (IP addresses) are respectively assigned to the printing device 10, the first terminal device 20, and the second terminal device 30. These devices can designate an IP address assigned to a communication destination and communicate with the communication destination.

As another example, the printing device 10, the first terminal device 20, and the second terminal device 30 may directly communicate with one another in a wired scheme such as Universal Serial Bus (USB) or may directly communicate with one another in a wireless scheme, not via a network, by Bluetooth (registered trademark) or the like.

The printing device 10 includes a first control unit 11, a first communication unit 12, and a first storage unit 13. The first control unit 11 comprehensively controls the units of the printing device 10. The first control unit 11 includes a central processing unit (CPU), a universal asynchronous receiver transmitter (UART) that manages input and output, and a field programmable gate array (FPGA) and a programmable logic device (PLD), which are logic circuits. The CPU is also referred to as processor.

The first storage unit 13 include memories such as a flash Read Only Memory (ROM) and a Hard Disk Drive (HDD), which are rewritable nonvolatile memories, and a Random Access Memory (RAM), which is a volatile memory.

The CPU of the first control unit 11 reads a program stored in the nonvolatile memories of the first storage unit 13 and executes the program using the RAM of the first storage unit 13 as a work area.

As explained below, the first storage unit 13 can perform storage, which is registration of first image information G1, and storage, which is setting of first setting information and second setting information.

The first communication unit 12 includes a circuit capable of communicating by radio or wire. The first communication unit 12 includes an antenna in the case of communication by radio and includes a connector in the case of communication by wire.

The first communication unit 12 is capable of communicating via the WAN 40. When performing transmission and reception to and from a communication destination, the printing device 10 performs the transmission and the reception through the first communication unit 12. However, in the following explanation, in order to simplify the explanation, the transmission and the reception being performed through the first communication unit 12 is s omitted. The same applies to transmission and reception performed through a second communication unit 22 of the first terminal device 20 and a third communication unit 32 of the second terminal device 30 explained below.

The printing device 10 further includes a printing unit 14. The printing unit 14 includes printing mechanisms such as a head, a conveyance roller, and a cutter (all of which are not illustrated). Examples of a medium to be printed include plain paper, synthetic paper, photographic paper, and a film. The medium is, for example, long continuous paper wound in a roll shape. The medium may have a sheet shape.

The printing unit 14 can pull out and convey the medium from a roll with the conveyance roller, perform printing with the head, and thereafter cut the medium with the cutter to obtain a print having a predetermined size.

The head is, for example, an inkjet type and ejects inks of a plurality of colors such as cyan, magenta, yellow, and black (CMYK) to perform printing.

The printing device 10 may include an input and output unit having the same configuration as a configuration of a second input and output unit 24 of the first terminal device 20 explained below.

The first terminal device 20 is, for example, a smartphone, a tablet terminal, or a computer. The first terminal device 20 includes a second control unit 21, a second communication unit 22, and a second storage unit 23. Since these components of the first terminal device 20 are substantially the same as the components of the printing device 10, explanation of the components is omitted.

The first terminal device 20 further includes a second input and output unit 24. The second input and output unit 24 is a user interface for a user.

The second input and output unit 24 is, for example, a touch panel display. The second input and output unit 24 includes a display panel, which is an output unit that displays various kinds of information, and a detection panel, which is an input unit.

The detection panel is configured to be laid over the display panel. The detection panel can detect operation of a finger or the like of the user with a method such as a capacitive scheme, a resistive film scheme, or an optical scheme.

In the second input and output unit 24, the input unit may be a keyboard, a mouse, buttons, or the like and the output unit may be a stand-type liquid crystal display or the like.

The second terminal device 30 is, for example, a smartphone, a tablet terminal, or a computer. The second terminal device 30 includes a third control unit 31, a third communication unit 32, a third storage unit 33, and a third input and output unit 34. Since these components of the second terminal device 30 are the same as the components of the first terminal device 20, explanation of the components is omitted.

As explained below, the second terminal device 30 does not have the first image information G1 and is a terminal device different from the first terminal device 20 having the first image information G1.

### 2. Control Method for the Printing System

### 2-1. Control Method for the First Terminal Device

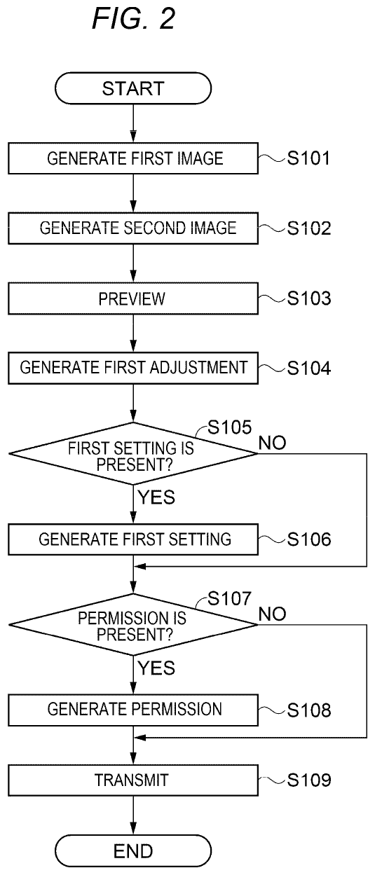

First, a control method for the first terminal device 20 included in a control method relating to the printing system 1 is explained with reference to FIGS. 2 to 7. In the following explanation, actually, the first control unit 11 of the printing device 10, the second control unit 21 of the first terminal device 20, and the third control unit 31 of the second terminal device 30 execute kinds of processing of the control units. In order to simplify the explanation, in the following explanation, the control units executing the processing is omitted. In the flowcharts including FIG. 2, a part is omitted, for example, the first image information G1 is referred to as first image.

As illustrated in FIG. 2, the first terminal device 20 starts processing, generates the first image information G1, which is background image information, (S101), and generates second image information G2, which is additional image information (S102).

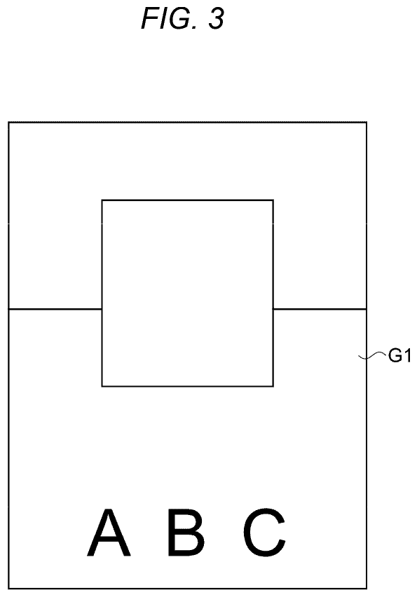

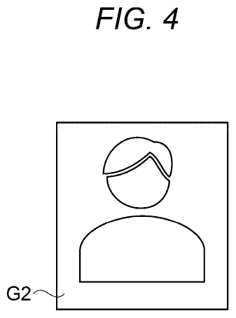

For example, as illustrated in FIG. 3, the first image information G1 is image information relating to a background image that is a background or the like of a print. For example, as illustrated in FIG. 4, the second image information G2 is image information relating to an additional image such as a person image that is at the center of the print.

The user can generate the first image information G1 and the second image information G2 using an application for drawing, photographing, or the like of the first terminal device 20 and store the first image information G1 and the second image information G2 in the second storage unit 23.

The first image information G1 and the second image information G2 may be stored in advance in the second storage unit 23 of the first terminal device 20 and the user may select the first image information G1 and the second image information G2 with the second input and output unit 24. In this case, the first terminal device 20 reading the selected first image information G1 and the selected second image information G2 from the second storage unit 23 is referred to as generating.

Specifically, the first image information G1 and the second image information G2 are respectively stored at addresses of predetermined regions of the RAM of the second storage unit 23 of the first terminal device 20. Results of kinds of processing explained below are also respectively stored in predetermined regions of the RAM having different addresses. Further, as explained below, addresses of the RAM of the second storage unit 23 also correspond to coordinates of preview screens and a first printing image P1.

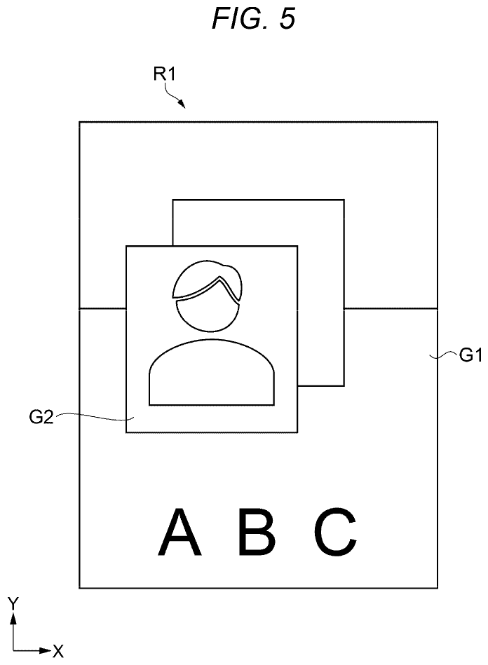

The first terminal device 20 superimposes and combines the first image information G1 and the second image information G2 and displays, with the second input and output unit 24, a first preview screen R1 illustrated in FIG. 5 (S103). Processing of the combination is performed on the RAM of the second storage unit 23 of the first terminal device 20.

The first preview screen R1 shows a preview screen before being adjusted by the user. In an example illustrated in FIG. 5, the second image information G2 is displayed further in the front than the first image information G1. However, the first image information G1 may be displayed further in the front than the second image information G2. The user is capable of selecting, with the second input and output unit 24, which of the first image information G1 and the second image information G2 is displayed in the front. A selection result may be included in first adjustment information AD1 explained below.

Arranging the second image information G2 further in front than the first image information G1 is also referred to as superimposing or overwriting the second image information G2 on the first image information G1.

The first image information G1 and the second image information G2 displayed on the first preview screen R1 illustrated in FIG. 5 are respectively displayed at positions corresponding to coordinates in an X-axis direction and a Y-axis direction on the first preview screen R1.

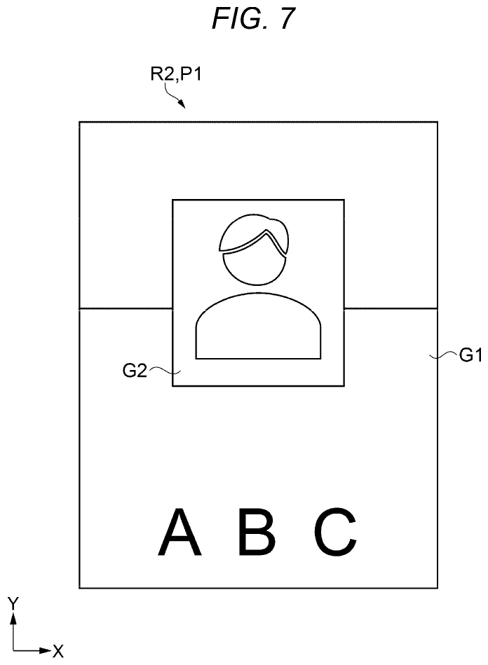

The coordinates in the X-axis direction and the Y-axis direction correspond to addresses of the RAM of the second storage unit 23 for the first terminal device 20 to display the first preview screen R1 on the second input and output unit 24. As illustrated in FIG. 7 referred to below, the same applies to a second preview screen R2 after being adjusted by the user.

For example, the first terminal device 20 reads the combined first image information G1 and second image information G2 in order from addresses in a predetermined range of the RAM of the second storage unit 23 and displays the combined first image information G1 and second image information G2 with the second input and output unit 24. As illustrated in FIG. 5, the first terminal device 20 can display the combined first image information G1 and second image information G2 at the positions of the coordinates in the X-axis direction and the Y-axis direction on the first preview screen R1 corresponding to the addresses of the RAM of the second storage unit 23.

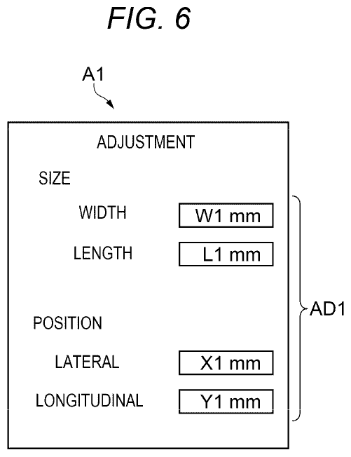

Then, as illustrated in FIG. 6 explained below, when the user adjusts the position of the second image information G2 displayed on the first preview screen R1 in order to change the position, the first terminal device 20 changes the address of the RAM of the second storage unit 23 where the second image information G2 is stored. That is, the first terminal device 20 changes the address of the RAM, rewrites the second image information G2, and superimposes the second image information G2 on the first image information G1.

As a result, as illustrated in FIG. 7 referred to below, the first terminal device 20 can display the second preview screen R2 in which the position of the second image information G2 is changed. The first terminal device 20 is capable of performing the processing in the same manner in the case of the first image information G1.

Referring back to FIG. 5, the explanation is continued. On the first preview screen R1 illustrated in FIG. 5, the first image information G1 and the second image information G2 are respectively combined and displayed based on original image information before being adjusted by the user.

The first terminal device 20 can display, with the second input and output unit 24, a first adjustment screen A1 illustrated in FIG. 6 together with the first preview screen R1 illustrated in FIG. 5. The first adjustment screen A1 is a screen for inputting first adjustment information AD1, which is information for adjusting the first image information G1 and the second image information G2.

The first adjustment screen A1 illustrated in FIG. 6 shows an example in which the first image information G1 is fixed without being adjusted and the second image information G2 is adjusted. In the first adjustment screen A1, the second image information G2 may be fixed and the first image information G1 may be adjusted. Further, in the first adjustment screen A1, the first image information G1 and the second image information G2 may be adjusted.

The first terminal device 20 acquires the first adjustment information AD1, which is first input information input by the user, via the second input and output unit 24. The first terminal device 20 can adjust the second image information G2 based on the acquired first adjustment information AD1 and reflect and display the second image information G2 on the first preview screen R1. As explained above, the first terminal device 20 changes the address of the RAM of the second storage unit 23 to rewrite the second image information G2.

In this way, the user can input the first adjustment information AD1 to the first adjustment screen A1 illustrated in FIG. 6 while viewing the first preview screen R1 illustrated in FIG. 5 on which a result of adjustment is reflected and adjust the second image information G2.

Specifically, the first adjustment information AD1 includes adjustment information relating to a size for enlarging or reducing with respect to image information to be adjusted by the user and adjustment information relating to a position for adjusting a position in the X-axis direction and the Y-axis direction.

In the example illustrated in FIG. 6, for the second image information G2, width W 1 mm and length L 1 mm, which are the adjustment information relating to the size, and lateral X 1 mm and longitudinal Y 1 mm, which are the adjustment information relating to the position, are input as the first adjustment information AD1.

In the first adjustment information AD1, in particular, adjustment information relating to a position such as the lateral X 1 mm and longitudinal Y 1 mm is referred to as first arrangement information relating to relative positions of the first image information G1 and the second image information G2. The user can input the first arrangement information on the first adjustment screen A1 while checking the relative positions of the first image information G1 and the second image information G2 on the first preview screen R1.

The input of the first arrangement information by the user is not limited to the example explained above. For example, the user can select and move, with touch operation or swipe operation, the second image information G2 displayed on the first preview screen R1. In this case, the input of the arrangement information via the first adjustment screen A1 can be omitted.

Based on the acquired first adjustment information AD1, the first terminal device 20 adjusts the size of the second image information G2 to the width W 1 mm and the length L 1 mm and further shifts and adjusts the position of the second image information G2 to be the lateral X 1 mm in the X-axis direction and the longitudinal Y 1 mm in the Y-axis direction.

When the first adjustment information AD1 includes information concerning enlargement or reduction, the first terminal device 20 adjusts the second image information G2 by enlarging or reducing the second image information G2 using, for example, an image scaling algorithm. When the first adjustment information AD1 includes the first arrangement information, which is information for adjusting a position, the first terminal device 20 adjusts the second image information G2 by shifting the position of the second image information G2, for example, changing and rewriting an address of the RAM.

As explained above, the first terminal device 20 can perform these kinds of processing using the RAM of the second storage unit 23 and display a result of the adjustment on the second input and output unit 24.

As explained above, the first terminal device 20 can adjust the second image information G2, superimpose the second image information G2 on the first image information G1 and combine the second image information G2 with the first image information G1, and display the second preview screen R2 intended by the user illustrated in FIG. 7. The first terminal device 20 can acquire the first adjustment information AD1 for displaying the second preview screen R2 intended by the user. These are stored in the RAM of the second storage unit 23.

Here, the first terminal device 20 acquiring the first adjustment information AD1 input to the second preview screen R2 via the second input and output unit 24 is referred to as generating the first adjustment information AD1 (S104).

Further, the first terminal device 20 displays, on the second input and output unit 24, a setting preview screen (not illustrated) for the user to input the first setting information. The first terminal device 20 determines whether the first setting information input to the setting preview screen by the user is present (S105).

When determining that the input first setting information is present (S105: YES), the first terminal device 20 acquires the first setting information. Here, the first terminal device 20 acquiring the first setting information input to the setting preview screen via the second input and output unit 24 is referred to as generating the first setting information (S106).

When it is determined that the input first setting information is absent (S105: NO), the first terminal device 20 does not generate the first setting information and proceeds to the next processing.

The first setting information indicates setting relating to printing of image information obtained by combining the first image information G1 and the second image information G2 in the printing device 10. The combined image information is a first printing image P1 explained below.

For example, the first setting information includes information relating to color correction for brightness, contrast, saturation, and the like at the time when ink is ejected onto the medium by the head of the printing unit 14 of the printing device 10. Specifically, the first setting information relating to color correction includes a coefficient of image processing at the time of conversion into ejection amounts of the inks of the colors by the head of the printing unit 14 of the printing device 10.

Further, the first setting information can include information for cutting the medium with the cutter of the printing device 10 and information for controlling a conveyance amount of the medium.

The first terminal device 20 displays, on the second input and output unit 24, a permission preview screen (not illustrated) for the user to input permission information. More specifically, the first terminal device 20 displays, for example, a message such as “register a background image in the printer?” and buttons of “Yes” and “No” and the like on the permission preview screen. Based on the display explained above, the first terminal device 20 determines whether the permission information input to the permission preview screen by the user is present (S107).

When the permission information is present, the first terminal device 20 indicates to the printing device 10 that registration of the first image information G1 is permitted. On the other hand, when the permission information is absent, the first terminal device 20 indicates to the printing device 10 that registration of the first image information G1 is prohibited.

When determining that the input permission information is present (S107: YES), the first terminal device 20 acquires the permission information. Here, the first terminal device 20 acquiring the permission information input to the permission preview screen via the second input and output unit 24 is referred to as generating the permission information (S108). Here, as explained below, the permission information may be restriction information.

When determining that the input permission information is absent (S107: NO), the first terminal device 20 does not generate the permission information and proceeds to the next processing.

The first terminal device 20 transmits the generated first image information G1, the generated second image information G2, and the generated first adjustment information AD1 to the printing device 10 (S109). At this time, when the generated first setting information and the generated permission information are present, the first terminal device 20 also transmits the generated first setting information and the generated permission information. Then, the first terminal device 20 ends the processing.

As explained above, the user can input the first adjustment information AD1 including the first arrangement information to the first adjustment screen A1 illustrated in FIG. 6 while viewing the first preview screen R1, illustrated in FIG. 5, in which the first image information G1 and the second image information G2 are combined by the first terminal device 20 and easily adjust the second image information G2.

The second preview screen R2 adjusted by the first adjustment information AD1 corresponds to the first printing image P1 to be printed by the printing device 10 explained below. The user can easily check the second preview screen R2.

Then, the first terminal device 20 only has to transmit the generated first adjustment information AD1 to the printing device 10 together with the first image information G1 and the second image information G2.

As explained above, when combining the first image information and the second image information, the user can check relative positions of the first image information and the second image information. In variable data printing, so-called variable printing, in which the second image information can be easily changed with respect to the first image information, the printing system 1 can improve convenience. The printing system 1 can also adjust the second image information and easily change the second image information together with the first image information.

2-2. Control Method for the Printing Device at the Time of Reception from the First Terminal Device

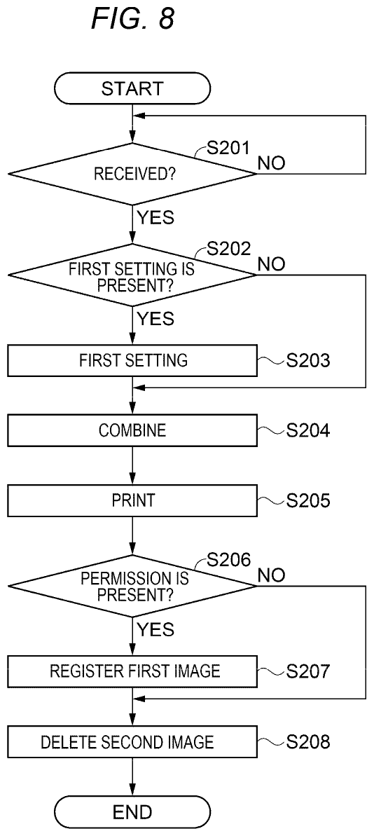

Subsequently, with reference to FIGS. 7 and 8, a control method for the printing device 10 at the time of reception from the first terminal device 20 included in the control method relating to the printing system 1 is explained. As in the case of the first terminal device 20 explained above, processing explained below is executed using the RAM of the first storage unit 13 of the printing device 10. As explained below, an address of the RAM of the first storage unit 13 corresponds to a coordinate of the first printing image P1, which is the print data, illustrated in FIG. 7.

As illustrated in FIG. 8, the printing device 10 starts the processing, determines whether the information explained above transmitted from the first terminal device 20 is received (S201), and waits until the information is received (S201: NO).

When determining that the information is received from the first terminal device 20 (S201: YES), the printing device 10 processes the information as explained below.

The information received by the printing device 10 includes the first image information G1, the second image information G2, and the first adjustment information AD1. When the first setting information and the permission information are present, these kinds of information are also included in the information received by the printing device 10.

The printing device 10 determines whether the first setting information is present in the received information (S202) and, when determining that the first setting information is absent (S202: NO), proceeds to the next processing.

When determining that the first setting information is present (S202: YES), the printing device 10 performs first setting, which is processing relating to the first setting information, as explained below (S203).

That is, when the first setting information includes information relating to color correction, for example, the printing device 10 registers, according to the information relating to the color correction, in the first storage unit 13, a coefficient of image processing for conversion into ejection amounts of the inks of the colors in association with brightness, contrast, saturation, and the like.

For example, when the first setting information includes information for cutting the medium, the printing device 10 registers, in the first storage unit 13, cutting the medium with the cutter after printing received image information.

Subsequently, the printing device 10 combines, based on the received first adjustment information AD1, the first image information G1 read from the first storage unit 13 and the received second image information G2 (S204).

Similarly to the case of the second preview screen R2 of the first terminal device 20 explained above, the printing device 10 can adjust the second image information G2 on the RAM of the first storage unit 13 based on the first adjustment information AD1 and superimpose the second image information G2 on the first image information G1 and combine the second image information G2 on the first image information G1.

As a result of the combination, as illustrated in FIG. 7, the printing device 10 can generate the first printing image P1 that is the same as the second preview screen R2 intended by the user. The first printing image P1 is stored in the RAM of the first storage unit 13 in a form printable on the medium by the printing unit 14.

Here, an example in which the printing device 10 fixes the first image information G1 and adjusts the second image information G2 based on the first adjustment information AD1 as in the case of the first terminal device 20 explained above is explained. The printing device 10 may fix the second image information G2 and adjust the first image information G1 or may adjust the first image information G1 and the second image information G2.

When the first adjustment information AD1 includes information concerning enlargement or reduction, the printing device 10 adjusts the received second image information G2 by enlarging or reducing the second image information G2 using, for example, an image scaling algorithm. When the first adjustment information AD1 includes the first arrangement information, which is information for adjusting a position, the printing device 10 shifts and adjusts the position.

Specifically, according to the received first adjustment information AD1 explained in the example illustrated in FIG. 6, the printing device 10 enlarges or reduces the second image information G2 to have the size of the width W 1 mm and the length L 1 mm and shifts the position of the second image information G2 to the position of the lateral X 1 mm in the X-axis direction and the longitudinal Y 1 mm in the Y-axis direction.

In RAM of the first storage unit 13, the printing device 10 superimposes the second image information G2 adjusted based on the first adjustment information AD1 in a region where the first image information G1 is stored. As explained above, the printing device 10 can superimpose the second image information G2 on the first image information G1 and combine the second image information G2 on the first image information G1 to generate the first printing image P1 illustrated in FIG. 7. At this time, when the first adjustment information AD1 includes selection information indicating which of the first image information G1 and the second image information G2 is set in the front, the printing device 10 only has to superimpose the first information G1 and the second information G2 according to the selection information of the first adjustment information AD1.

The coordinates in the X-axis direction and the Y-axis direction illustrated in FIG. 7 correspond to addresses in a predetermined range of the RAM of the first storage unit 13 for the printing device 10 to print the first printing image P1 on the medium.

The printing device 10 reads, according to the order of the addresses, the first printing image P1 from the RAM of the first storage unit 13 in which the first printing image P1 is stored and prints the first printing image P1 on the medium with the printing unit 14 (S205).

When printing the first printing image P1 obtained by combining the first image information G1 and the second image information G2 are combined, the printing device 10 executes processing based on the first setting information as explained below.

That is, the printing device 10 refers to the first storage unit 13 and, when the first setting information relating to color correction is set, converts the first printing image P1 into ejection amounts of the inks of the colors according to a coefficient of image processing relating to color correction and prints the first printing image P1.

The printing device 10 refers to the first storage unit 13 and, when the first setting information relating to cutting is set, prints the first printing image P1 and thereafter automatically cuts the medium with the cutter. When the first setting information relating to cutting is absent, after printing the first printing image P1, the printing device 10 does not automatically cut the medium with the cutter. However, in this case, via a not-illustrated cut execution button provided in the printing device 10 or via the first terminal device 20, the user can instruct the printing device 10 to execute cutting.

As a result, the printing device 10 can print the medium as a print as indicated by the first printing image P1 illustrated in FIG. 7 intended by the user.

The printing device 10 may register the first setting information in a flash ROM of the first storage unit 13 and read and use the first setting information even after the power is turned on again.

As explained above, the presence of the permission information indicates that the first terminal device 20 permits the printing device 10 to register the first image information G1. On the other hand, the absence of the permission information indicates that the first terminal device 20 does not permit the printing device 10 to register the first image information G1 and prohibits the registration.

The printing device 10 determines whether the permission information is present in the received information (S206) and, when determining that the permission information is absent (S206: NO), proceeds to the next processing. When the permission information is absent, the printing device 10 may delete the first image information G1 from the first storage unit 13.

When determining that the permission information is present (S206: YES), the printing device 10 registers the first image information G1 in the first storage unit 13 (S207). At this time, when the first setting information is present, the printing device 10 may register the first setting information in the first storage unit 13 in association with the first image information G1. Note that registering information in the first storage unit 13 is also referred to as storing information in the first storage unit 13.

Note that, according to the same series of processing as the series of processing explained above, the first terminal device 20 can transmit another kind of the first image information G1 to the printing device 10 and the printing device 10 can register the received other kind of the first image information G1. As explained above, the printing device 10 can also register a plurality of pieces of first image information G1.

The printing device 10 deletes the second image information G2 from the first storage unit 13 (S208) and ends the processing. Here, for deleting timing the second image information G2 from the first storage unit 13 is timing after the first printing image P1 is generated or after the first printing image P1 is printed on the medium. As another example, the deletion timing may be timing when the printing device 10 receives another kind of image information anew in subsequent another print job. That is, the second image information G2 may be set in a state of being capable of being overwritten and deleted.

The first image information G1 and the second image information G2 are preferably not used in other uses in terms of security. For this reason, the printing device 10 registers the first image information G1 relating to a background image or the like in the printing device 10 only when the permission information is present. On the other hand, the printing device 10 deletes the second image information G2 relating to a person image or the like more important in terms of security so that the second image information G2 cannot be reused.

When receiving the permission information from the first terminal device 20, the printing device 10 can generate restriction information indicating permission of reuse of the first image information G1. On the other hand, when not receiving the permission information from the first terminal device 20, the printing device 10 can generate restriction information indicating prohibition of reuse of the first image information G1.

When receiving the permission information, the printing device 10 can also set the restriction information as information indicating permission of reprinting and, when not receiving the permission information, the printing device 10 can also set the restriction information as information indicating prohibition of reprinting.

As explained above, when the permission information is present, the printing device 10 can register the first image information G1 and set the permission information as the restriction information as information indicating that reuse is permitted. On the other hand, when the permission information is absent, the printing device 10 does not register the first image information G1 and can generate, as restriction information reflecting that the absence of the permission information, information indicating that reuse is prohibited.

The printing device 10 registers the restriction information in the flash ROM of the first storage unit 13 such that the restriction information can be read and used even after the power is turned on again.

### 2-3. Control Method for the Second Terminal Device

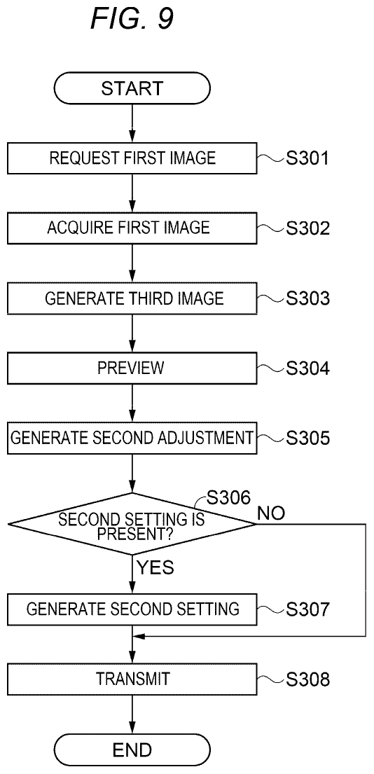

Subsequently, a control method for the second terminal device 30 included in the control method relating to the printing system 1 is explained with reference to FIGS. 9 to 13. In the following explanation, content different from the content of the control method for the first terminal device 20 explained above is mainly explained and the same content is omitted.

As illustrated in FIG. 9, the second terminal device 30 starts processing and requests the first image information G1 from the printing device 10 (S301). When the restriction information registered in the first storage unit 13 indicates reuse permission, the printing device 10 can transmit the registered first image information G1 to the second terminal device 30.

In this case, the second terminal device 30 can receive and acquire the first image information G1 from the printing device 10 (S302). The second terminal device 30 can reuse the first image information G1 registered in advance in the printing device 10. That is, after the printing device 10 registers the first image information G1, the second terminal device 30 acquires the first image information G1 from the printing device 10 and reuses the first image information G1.

In the present embodiment, an example in which the printing device 10 registers the first image information G1 in advance using the first terminal device 20 is explained. However, when the first image information G1 is already registered in the printing device 10, the printing system 1 only has to include the second terminal device 30 and the printing device 10 and may not include the first terminal device 20.

For convenience of illustration, FIG. 9 illustrates a case in which the second terminal device 30 acquires the first image information G1 from the printing device 10.

On the other hand, when the restriction information indicates prohibition of reuse, the printing device 10 does not transmit the first image information G1 to the second terminal device 30. As a result, although omitted in FIG. 9, the second terminal device 30 cannot acquire the first image information G1. The second terminal device 30 may display, with the second input and output unit 24, an error indicating that the first image information G1 has not been successfully acquired and notify the user to that effect and end the processing.

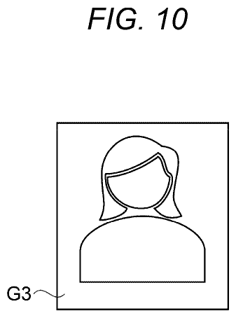

The second terminal device 30 generates third image information G3, which is additional image information, (S303). For example, as illustrated in FIG. 10, the third image information G3 is image information of a person or the like different from the second image information G2 and is image information different from the second image information G2. The first image information G1 and the third image information G3 are respectively stored at addresses of predetermined regions of the RAM of the third storage unit 33 of the second terminal device 30. Results of kinds of processing explained below are also respectively stored in predetermined regions of RAM having different addresses. The addresses of the RAM of the third storage unit 33 also correspond to coordinates of the preview screens.

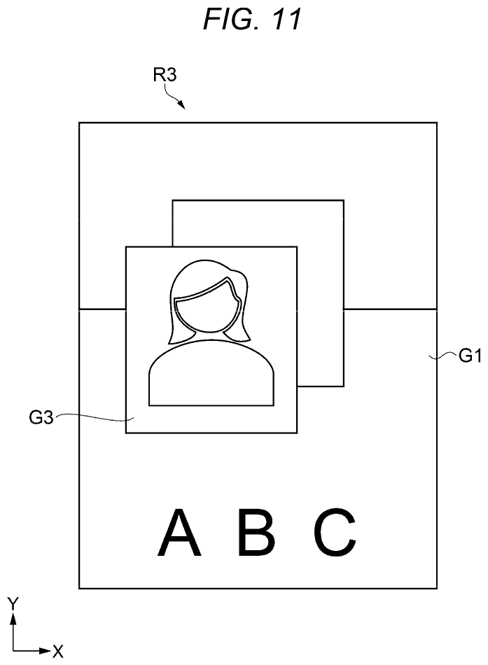

The second terminal device 30 superimposes and combines the acquired first image information G1 and the generated third image information G3 and displays, with the third input and output unit 34, a third preview screen R3 illustrated in FIG. 11 (S304).

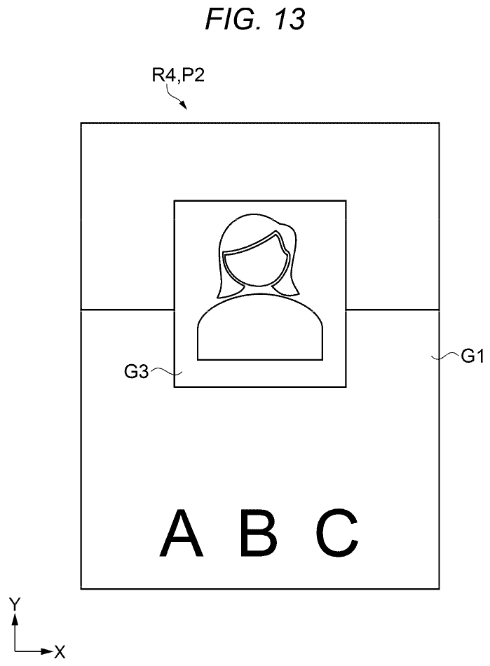

Coordinates in the X-axis direction and the Y-axis direction on the third preview screen R3 illustrated in FIG. 11 correspond to addresses of the RAM of the third storage unit 33 for the second terminal device 30 to display the third preview screen R3 on the third input and output unit 34. The same applies to a fourth preview screen R4 after being adjusted illustrated in FIG. 13 referred to below.

The first image information G1 and the third image information G3 of the third preview screen R3 illustrated in FIG. 11 are original image information before adjustment.

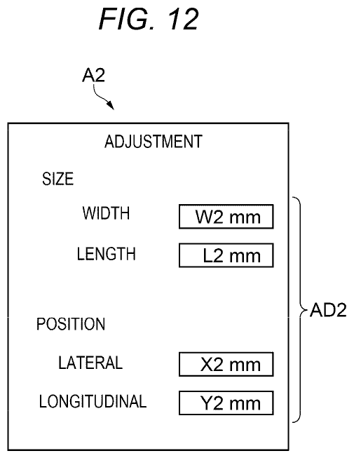

The second terminal device 30 displays, with the third input and output unit 34, the second adjustment screen A2 illustrated in FIG. 12 together with the third preview screen R3 illustrated in FIG. 11. The second adjustment screen A2 is a screen for the user to input second adjustment information AD2, which is information for adjusting the first image information G1 and the third image information G3.

The second adjustment screen A2 illustrated in FIG. 12 shows an example in which the first image information G1 is fixed without being adjusted and the third image information G3 is adjusted. In the second adjustment screen A2, the third image information G3 may be fixed and the first image information G1 may be adjusted. Further, in the second adjustment screen A2, the first image information G1 and the third image information G3 may be adjusted.

The second terminal device 30 acquires the second adjustment information AD2, which is second input information input by the user, via the third input and output unit 34. The second terminal device 30 can adjust the third image information G3 based on the acquired second adjustment information AD2 and reflect and display the third image information G3 on the third preview screen R3.

The second adjustment information AD2 includes adjustment information relating to a size and adjustment information relating to a position for the third image information G3. In the example illustrated in FIG. 12, width W 2 mm and length L 2 mm, which are the adjustment information relating to a size, are input and lateral X 2 mm and longitudinal Y 2 mm, which are the adjustment information relating to a position and is second arrangement information, are input. The second arrangement information is information relating to relative positions of the first image information G1 and the third image information G3 in the second adjustment information AD2. Input of the second arrangement information by the user is not limited to the example explained above. As explained above, the user can perform selection, movement or the like of the third image information G3 with touch operation or swipe operation.

Based on the acquired second adjustment information AD2, the second terminal device 30 adjusts the size of the third image information G3 to have the width W 2 mm and the length L 2 mm, and further shifts and adjusts the position of the third image information G3 to have the lateral X 2 mm in the X-axis direction and the longitudinal Y 2 mm in the Y-axis direction.

As explained above, the second terminal device 30 can adjust the third image information G3, superimpose the third image information G3 on the first image information G1 and combine the third image information G3 with the first image information G1, and display the fourth preview screen R4 intended by the user illustrated in FIG. 13. The second terminal device 30 can acquire the second adjustment information AD2.

Here, the second terminal device 30 acquiring the second adjustment information AD2 input to the fourth preview screen R4 via the third input and output unit 34 is referred to as generating the second adjustment information AD2 (S305).

Further, the second terminal device 30 displays a setting preview screen (not illustrated) for the user to input the second setting information on the third input and output unit 34. The second terminal device 30 determines whether the second setting information input to the setting preview screen by the user is present (S306).

When determining that the input second setting information is present (S306: YES), the second terminal device 30 acquires the second setting information. Here, the second terminal device 30 acquiring the second setting information input to the setting preview screen via the third input and output unit 34 is referred to as generating the second setting information (S307).

On the other hand, when determining that the input second setting information is absent (S306: NO), the second terminal device 30 does not generate the second setting information and proceeds to the next processing.

As explained above, the printing device 10 sometimes registers the first setting information received from the first terminal device 20 in the first storage unit 13 in association with the first image information G1. In this case, the second terminal device 30 may not generate the second setting information or transmit the second setting information to the printing device 10. The printing device 10 can use the registered first setting information instead of the second setting information in processing explained below.

The second setting information indicates setting relating to printing of image information obtained by combining the first image information G1 and the third image information G3 in the printing device 10. The combined image information is a second printing image P2 explained below.

For example, the second setting information can include information relating to color correction. Further, the second setting information can include information for cutting the medium with the cutter.

The second terminal device 30 transmits the generated first image information G1, the generated third image information G3, and the generated second adjustment information AD2 to the printing device 10 (S308). At this time, when the generated second setting information is present, the second terminal device 30 also transmits the generated second setting information. Then, the second terminal device 30 ends the processing.

When the printing device 10 has registered the first image information G1, the second terminal device 30 may not transmit the first image information G1 to the printing device 10.

When the printing device 10 has registered a plurality of pieces of first image information G1, the second terminal device 30 is capable of selecting and acquiring one piece of first image information G1 from the printing device 10. In this case, the second terminal device 30 only has to transmit information indicating that the one piece of first image information G1 has been selected to the printing device 10 without transmitting the one piece of first image information G1 to the printing device 10.

As explained above, unlike the first terminal device 20, the second terminal device 30 does not have the first image information G1 but can acquire the first image information G1 from the printing device 10 when the restriction information indicates permission of reuse. The user generates the third image information G3 with the second terminal device 30. Then, the user can input the second adjustment information AD2 including the second arrangement information to the second adjustment screen A2 illustrated in FIG. 12 while viewing the third preview screen R3, illustrated in FIG. 11, in which the first image information G1 and the third image information G3 are combined, by the second terminal device 30, and easily adjust the third image information G3.

The fourth preview screen R4 adjusted by the second adjustment information AD2 corresponds to the second printing image P2 to be printed by the printing device 10 explained below, and can be easily checked by the user.

The first image information G1 generated by the first terminal device 20 is reusable by the second terminal device 30 via the printing device 10. Similarly, the first terminal device 20 can also reuse the first image information G1. The first image information G1 can be shared by the first terminal device 20 and the second terminal device 30 via the printing device 10.

2-4. Control Method for the Printing Device at the Time of Reception from the Second Terminal Device

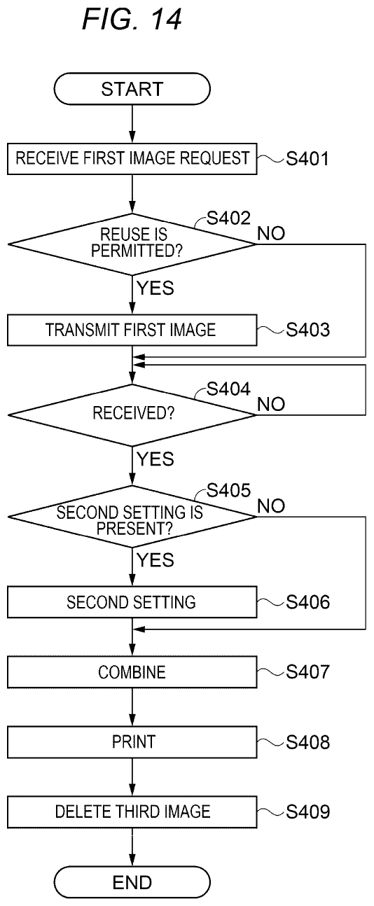

Subsequently, with reference to FIGS. 13 and 14, a control method for the printing device 10 at the time of reception from the second terminal device 30 included in the control method relating to the printing system 1 is explained. In the following explanation, content different from the content of the control method for the printing device at the time of reception from the first terminal device 20 explained above is mainly explained and the same content is omitted.

As illustrated in FIG. 14, the printing device 10 starts processing and receives a request for transmission of the first image information G1 from the second terminal device 30 (S401).

As explained above, based on the permission information, the restriction information indicates permission or prohibition of reuse of the first image information G1. The printing device 10 refers to the first storage unit 13 and determines whether the restriction information indicates permission of reuse (S402).

When it is determined that the restriction information indicates permission of reuse (S402: YES), the printing device 10 reads the first image information G1 registered in the first storage unit 13 and transmits the first image information G1 to the second terminal device 30 (S403). The second terminal device 30 can reuse the first image information G1 registered in the printing device 10.

On the other hand, when that the determining restriction information indicates prohibition of reuse (S402: NO), the printing device 10 does not transmit the first image information G1 to the second terminal device 30. In this case, the first image information G1 is sometimes not registered in the first storage unit 13 of the printing device 10. The printing device 10 may transmit, to the second terminal device 30, an error indicating that the first image information G1 cannot be transmitted and end the processing.

The printing device 10 determines whether the information transmitted from the second terminal device 30 is received (S404) and waits until the information is received (S404: NO).

When determining that the information is received from the second terminal device 30 (S404: YES), the printing device 10 performs processing as explained below.

The information received by the printing device 10 includes the third image information G3 and the second adjustment information AD2. When the second setting information is set, the second setting information is also included in the information received by the printing device 10.

As explained above, the printing device 10 acquires the registered first image information G1 with reference to the first storage unit 13.

At this time, the printing device 10 sometimes registers a plurality of pieces of first image information G1. In this case, the printing device 10 can select and acquire one piece of first image information G1 with reference to the first storage unit 13 based on information, transmitted by the second terminal device 30, indicating that the one piece of first image information G1 has been selected. The printing device 10 can transmit the one piece of first image information G1 in response to a request from the second terminal device 30.

The printing device 10 determines whether the second setting information is present in the received information (S405) and, when determining that the second setting information is absent (S405: NO), proceeds to the next processing.

When determining that the second setting information is present (S405: YES), the printing device 10 performs second setting, which is processing relating to setting, as explained below (S406).

That is, when the second setting information includes information relating to color correction, for example, the printing device 10 registers, according to the information relating to color correction, in the first storage unit 13, a coefficient of image processing for conversion into ejection amounts of the inks of the colors.

For example, when the second setting information includes information for cutting the medium, the printing device 10 registers, in the first storage unit 13, cutting the medium with the cutter.

Subsequently, the printing device 10 combines, based on the received second adjustment information AD2, the first image information G1 read from the first storage unit 13 and the received third image information G3 (S407).

As in the case of the fourth preview screen R4 of the second terminal device 30 explained above, on the RAM of the first storage unit 13, the printing device 10 can adjust the third image information G3 based on the second adjustment information AD2 and superimpose the third image information G3 on the first image information G1 and combine the third image information G3 on the first image information G1.

Here, as in the case of the second terminal device 30 explained above, an example in which the first image information G1 is fixed and the third image information G3 is adjusted based on the second adjustment information AD2 is explained. However, the third image information G3 may be fixed and the first image information G1 may be adjusted or the first image information G1 and the third image information G3 may be adjusted.

As a result of the combination, as illustrated in FIG. 13, the printing device 10 can generate the second printing image P2 similar to the fourth preview screen R4 intended by the user. The second printing image P2 is stored in the RAM of the first storage unit 13 in a form printable on the medium by the printing unit 14.

Specifically, according to the received second adjustment information AD2 illustrated in the example illustrated in FIG. 12, the printing device 10 enlarges or reduces the third image information G3 to have a size of the width W 2 mm and the length L 2 mm and shifts and adjusts the position of the third image information G3 to a position of the lateral X 2 mm in the X-axis direction and the longitudinal Y 2 mm in the Y-axis direction.

In the RAM of the first storage unit 13, the printing device 10 superimposes, based on the second adjustment information AD2, the adjusted third image information G3 explained above on the region where the first image information G1 is stored.

When the second adjustment information AD2 includes selection information indicating which of the first image information G1 and the third image information G3 is set in the front, the printing device 10 superimposes the first image information G1 and the third image information G3 according to the selection information.

The coordinates in the X-axis direction and the Y-axis direction illustrated in FIG. 13 correspond to addresses in a predetermined range of the RAM of the first storage unit 13 for the printing device 10 to print the second printing image P2 on the medium.

The printing device 10 reads, according to the order of the addresses, the second printing image P2 from the RAM of the first storage unit 13 in which the second printing image P2 is stored and prints the second printing image P2 on the medium with the printing unit 14 (S408).

In this way, when the restriction information indicates permission of reuse, the printing device 10 can reuse the first image information G1. As explained above, the restriction information can also be information indicating permission reprinting. When the restriction information indicates permission of reprinting, the printing device 10 can reprint the first image information G1. On the other hand, when the restriction information indicates prohibition of reprinting, printing device 10 does not reprint the first image information G1.

When printing the second printing image P2 in which the first image information G1 and the third image information G3 are combined, the printing device 10 executes processing based on the second setting information as explained below.

The printing device 10 refers to the first storage unit 13 and, when the second setting information relating to color correction is set, converts the second printing image P2 into ejection amounts of the inks of the colors according to a coefficient of image processing relating to color correction and prints the second printing image P2.

The printing device 10 refers to the first storage unit 13 and, when the second setting information relating to cutting is set, prints the second printing image P2 and thereafter cuts the medium with the cutter.

Even when the second setting information is absent, when the first setting information is set in the first storage unit 13, the printing device 10 can perform processing in the same manner as in the case of the second setting information explained above using the first setting information.

As a result, the printing device 10 can print the medium as a print as indicated by the second printing image P2 illustrated in FIG. 13 intended by the user.

The printing device 10 may register the second setting information in the flash ROM of the first storage unit 13 and read and use the second setting information even after the power is turned on again.

The printing device 10 deletes the third image information G3 from the first storage unit 13 (S409) and ends the processing. The printing device 10 deletes the third image information G3 such as a person image important in terms of security not to be reusable. Here, timing for deleting the third image information G3 from the first storage unit 13 is timing after the second printing image P2 is generated or after the second printing image P2 is printed on the medium. As another example, the deletion timing may be timing when the printing device 10 receives another kind of image information anew in subsequent another print job. That the third image information G3 may be set in a state of being capable of being overwritten and deleted.

As explained above, the printing system 1 includes the second terminal device 30 and the printing device 10 capable of communicating with the second terminal device 30.

The printing device 10 has registered the first image information G1 and the second terminal device 30 acquires the first image information G1 from the printing device 10 and transmits the third image information G3 and the second adjustment information AD2 including the second arrangement information relating to relative positions of the first image information G1 and the third image information G3 to the printing device 10.

The printing device 10 can combine the first image information G1 and the received third image information G3 and print the combined image information according to the second arrangement information based on the reception from the second terminal device 30.

As explained above, the printing device 10 is capable of communicating with the second terminal device 30 and includes the printing unit 14, the first control unit 11, and the first storage unit 13. The first storage unit 13 registers the first image information G1. When receiving the third image information G3 and the second adjustment information AD2 including the second arrangement information relating to the relative positions of the first image information G1 and the third image information G3 from the second terminal device 30, the first control unit 11 can combine the first image information G1 read from the first storage unit 13 and the received third image information G3 according to the second arrangement information and print the combined image information with the printing unit 14.

As a result, in the printing system 1 including the printing device 10 explained above, even the second terminal device 30 not having the first image information G1 can reuse the first image information G1 stored in the printing device 10 by the first terminal device 20. The second terminal device 30 can combine the generated third image information G3 and the first image information G1 acquired from the printing device 10 and display the combined image information.

When combining the first image information G1 and the third image information G3 and printing the combined image information, the user can easily check relative positions of the first image information G1 and the third image information G3 with the second terminal device 30. At this time, by acquiring the second adjustment information AD2 input to the second terminal device 30 by the user, the printing device 10 can combine the first image information G1 and the third image information G3 and easily print the second printing image P2 intended by the user. As explained above, the printing system 1 can facilitate reuse and reprinting of the first image information G1 and improve convenience.

The embodiment is explained in detail with reference to the drawings. However, specific components are not limited to the embodiment and may be, for example, changed, substituted, or deleted without departing from the gist of the present disclosure.

In the above explanation, the head of the printing unit 14 is explained as the example of the inkjet type but may be a head of another type such as an electrophotographic type.

In the above explanation, the example in which the printing system 1 includes one second terminal device 30 is explained. However, the printing system 1 may include a plurality of devices equivalent to the second terminal device 30. The respective devices can combine image information different from the second image information G2 and the first image information G1 and print the combined information on the printing device 10.

In the above explanation, when the permission information is absent, the printing device 10 generates the restriction information indicating that reuse is prohibited. When the restriction information is not generated and the permission information is absent, the printing device 10 may determine to prohibit reuse of the first image information G1 and may not transmit the first image information G1 to the second terminal device 30.

What is claimed is:

1. A printing system comprising:
a second terminal device; and
a printing device capable of communicating with the second terminal device, wherein
the printing device has registered first image information,
the second terminal device acquires the first image information from the printing device and transmits third image information and second arrangement information, which relates to relative positions of the first image information and the third image information, to the printing device, and
the printing device combines, based on reception from the second terminal device, according to the second arrangement information, the first image information and the received third image information and prints the combined image information.

2. The printing system according to claim 1, wherein
the printing device is capable of communicating with a first terminal device,
the first terminal device transmits the first image information, second image information different from the third image information, and first arrangement information relating to relative positions of the first image information and the second image information, to the printing device
the printing device combines, based on reception from the first terminal device, according to the first arrangement information, the first image information and the second image information and prints the combined image information and registers the first image information, and
the second terminal device acquires the first image information from the printing device after the printing device registers the first image information.

3. The printing system according to claim 2, wherein the first terminal device displays a first preview screen in which the first image information and the second image information are superimposed and generates the first arrangement information based on input first input information.

4. The printing system according to claim 1, wherein the second terminal device displays a third preview screen in which the first image information and the third image information are superimposed and generates the second arrangement information based on input second input information.

5. The printing system according to claim 1, wherein the printing device deletes the third image information after combining the first image information and the third image information and printing the combined image information.

6. The printing system according to claim 2, wherein the printing device deletes the second image information after combining the first image information and the second image information and printing the combined image information.

7. The printing system according to claim 1, wherein the printing device has registered setting information corresponding to the first image information and executes, based on the setting information, setting concerning printing of an image obtained by combining the first image information received from the second terminal device and the third image information.

8. The printing system according to claim 1, wherein, when the printing device has registered a plurality of pieces of the first image information, the second terminal device is capable of selecting and acquiring one of the plurality of pieces of the first image information from the printing device.

9. A control method for a printing system including a second terminal device and a printing device capable of communicating with the second terminal device, the control method comprising:
the printing device registering first image information;
the second terminal device acquiring the first image information from the printing device and transmitting third image information and second arrangement information, which relates to relative positions of the first image information and the third image information, to the printing device; and
the printing device combining, based on reception from the second terminal device, according to the second arrangement information, the registered first image information and the received third image information and printing the combined image information.

10. The control method for the printing system according to claim 9, wherein
the printing system includes a first terminal device, and the printing device is capable of communicating with the first terminal device,
the first terminal device transmits the first image information, second image information different from the third image information, and first arrangement information relating to relative positions of the first image information and the second image information, to the printing device,
the printing device combines, based on reception from the first terminal device, according to the first arrangement information, the first image information and the second image information and prints the combined image information and registers the first image information, and
the second terminal device acquires the first image information from the printing device after the printing device registers the first image information.

11. A printing device capable of communicating with a second terminal device and including a printing unit, a control unit, and a storage unit, wherein
the storage unit has registered first image information, and
when receiving third image information and second arrangement information, which relates to relative positions of the first image information and the third image information, from the second terminal device, the control unit combines, according to the second arrangement information, the first image information read from the storage unit and the received third image information and prints the combined image information with the printing unit.

12. The printing device according to claim 11, wherein
the printing device is capable of communicating with a first terminal device, and
when receiving the first image information, second image information different from the third image information, and first arrangement information relating to relative positions of the first image information and the second image information from the first terminal device, the control unit combines the first image information and the second image information according to the first arrangement information and prints the combined image information with the printing unit and registers the first image information, and transmits the first image information to the second terminal device after registering the first image information.
